(19) United States
(12) Patent Application Publication
(10) Pub. No.: US 2013/0167281 A1
(43) Pub. Date: Jul. 4, 2013

(54) SOLE BASEBALL GLOVE

(71) Applicant: JAMES EDWARD JENNINGS, Superior, CO (US)

(72) Inventor: JAMES EDWARD JENNINGS, Superior, CO (US)

(21) Appl. No.: 13/572,672

(22) Filed: Oct. 13, 2012

Related U.S. Application Data
(63) Continuation-in-part of application No. 29/348,860, filed on Feb. 16, 2010, now Pat. No. D665538.

(51) Int. Cl. A63B 71/14; B29C 35/00

(52) U.S. Cl. CPC A63B 71/143; B29C 35/002
USPC 2/19; 156/196

(57) ABSTRACT

This invention relates to a Sole baseball glove/mitt sole and a method of making the same such that a stamped, injection embossed molded glove shell parts may be achieved and recycled. This way the materials we use will go through many cycles of design, manufacture and use. A baseball glove having a foam rubber padding shell with low rebound and energy damping properties is constructed as a shoe sole. A baseball glove method comprising an air, EVA balls, gas or gel bladder disposed insert prior for a sole assembly of a shoe. A further object of the present invention is to provide a consistent flex pattern by the appropriate pre-curved system design while improving traditional glove design details and materials.

### CROSS REFERENCE TO RELATED APPLICATIONS

This is a Continuation of application Ser. No. 29/348,860, filed Feb. 16, 2010, now patent No. D665,538, granted Aug. 14, 2012, Continuation in part of application Ser. No. 29/426,250, filed Jul. 2, 2012 and application Ser. No. 29/426,440, filed Jul. 5, 2012.

### BACKGROUND OF THE INVENTION

This invention relates to a Sole baseball glove and a method of making the same such that a molded glove shell may be achieved and recycled as footwear. This way the materials we use will go through many cycles of design, manufacture and use by grinding and creating pellets. A baseball glove made out of flexible plastic rubber like a shoe sole. This new Sole glove may be glued onto the palm side of a special lightweight leather batting glove back. Among the benefits of a lasted, bonded or glued glove are that it doesn't need breaking in, the material used to make it is cheaper than leather, and the glove is textured, making it easier to grip and catch a ball.

In the past, conventional baseball gloves have been constructed of leather, traditionally employing hand-stitching, a web portion that was usually fastened by rawhide between the thumb and index finger of the glove, independent finger sockets joined by rawhide lacing, and often with surface padding inserts. Chan US D526,447 designed a conventional ball-catching gloves of this type with shoelace, a ball-catching, palm portion is made of a natural leather such as cowhide, and a rear portion is either made of a natural leather, such as above, or a synthetic leather and joined to the palm portion to form a body. Leather gloves have become extremely expensive because of both manufacturing and material costs. The present invention provides a glove shell made of polymer which is formed in a injection molding process, greatly reducing the cost of manufacture. A vulc style and cupsole style handwear and a method for manufacturing the handwear are disclosed. The handwear includes a midsole that is directly attached to the upper. The midsole may be attached to the outsole by adhesive. In the method of manufacturing the handwear, the upper and an outsole are disposed a set distance apart. Polyurethane or other material for providing cushioning to the handwear is either injected between the upper and outsole or poured onto the outsole and the upper is traversed over the outsole so as to define the mold for defining the midsole. The polyurethane is directly attached to the upper and adhered to the outsole/cupsole. Also, vulcanization is far more flexible than a cupsole as deposed by U.S. Patent to Cheskin U.S. Pat. No. 4,676,010 and patent applications by Fleming et. al. Ser. Nos. 12/695,609, 12/695,609.

Hitherto, the sole has three layers: insole, midsole, and outsole. The insole is a thin layer of man-made ethylene vinyl acetate (EVA). The components of the midsole, which provides the bulk of the cushioning, will vary among manufacturers. Generally it consists of polyurethane surrounding another material such as gel or liquid silicone, or polyurethane foam given a special brand name by the manufacturer. In some cases the polyurethane may surround capsules of compressed air. Outsoles are usually made of carbon rubber, which is hard, or blown rubber, a softer type, although manufacturers use an assortment of materials to produce different textures on the outsole. Patents U.S. Pat. No. 5,042,176, U.S. Pat. No. 4,219,945, U.S. Pat. No. 4,936,029 by Rudy exhibit air and gas sole compression and U.S. Pat. No. 4,768,295 by Ito is an example of gel cushioning.

The present invention may be stamped from a material which integrally forms the overall resilient shell of the glove, the shell having a surface design, front and back to ultimately assimilate an athletic shoe sole and glove in appearance. After stamping and removal, the back surface of the resilient shell is then lasted, glued and stitched or heat bonded attached to the front to form the glove.

### DESCRIPTION OF THE BACKGROUND ART

The technology for game gloves, whether for baseball, softball or the like involves a glove particularly sized and configured for the preference of the player. Human factors involved with glove design relate to a plurality of factors. One human factor, hand motion, includes two ways for closing the hand The thumb to the index finger, a natural motion which is the strongest motion. In the alternative, the thumb can move to the ring finger, the traditional glove closing motion. Strength is effected by the finger position. Two fingers are stronger than one, but there is less strength when the fingers are spread apart.

Another human factor relates to the flex points on the hand The palm has two flex points, the first is across the palm about one half inch below the base of the fingers. The second begins at the base of the index finger around the thumb. These flex points create a wide wedge when using the natural hand motion and a narrow wedge with the traditional hand motion. The back of the hand also has flex lines, a first is across the knuckles and a second begins about half inch outside of the index finger straight to wrist at the base of the hand There is an additional flex line along the middle knuckle of the fingers.

In comparing glove design versus hand design, current gloves are designed for the natural hand closure. The flex lines will create a wide wedge. The thumb lays across the fingers in the closed position which reduces the size of the well. The enclosed backs, however, hinder closure while material layering hinders flex. Design recommendations for traditional closures include the fact that the flex lines should create a narrow wedge. The thumb of the glove lays parallel to the ring hand pinkie finger which maximizes the size of the well. The enclosed backs hinder closure. The pocket includes the index finger.

With regard to cradle material stiffeners, advanced glove designs require stiffness along the thumb and outer fingers to enhance closure as well as a stiff connection between the closing fingers and the glove.

Cushioning should be along the lower palm of the hand, in the palm of the hand, and provide for the index finger. With respect to fit features for glove retaining, considerations should include: (1) thumb and finger internal loops, (2) the fan shaped spreading of fingers, (3) the well shape which allows gravity to assist in glove retention, (4) tight finger slots with sufficient room for fingers, and (5) finger tension on glove.

With regard to hand position versus glove performance, two hand positions are considered. The traditional position and the position of fingers closer together with the thumb at 90 degrees. This latter position offers a larger pocket but less sensitivity.

In view of the foregoing, a preferred glove concept employs (1) air/eva balls/gas/gel in a bladder in the palm of the hand for cushioning, (2) a padding system that retains the fingers, (3) a shock absorbing system that encloses the ball after the catch, (4) quilted air bladders to create the proper flex points and (5) a closure system that enhances the snug fit of the glove.

Accordingly, it is an object of the present invention to provide an improved game glove including a front portion and a back portion defining a hand space there between and forming a major region for receiving the fingers of the wearer and a minor region for receiving the thumb of the wearer; an opening at one edge of the glove for the passage of the hand of a wearer into the hand space; a bladder positioned in the hand space, the bladder having a major portion in the major region of the glove and a minor portion in the minor region for the glove; and a gas or gel system to inflate the bladder to improve the fit of the glove on a wearer's hand

A further object of the invention is to implement light weight air bladders into baseball and softball gloves to provide an inner structure for fielding and shock absorption.

A further object of the present invention is to provide a consistent flex pattern by the appropriate air/eva balls/gas/gel system design while improving traditional glove design details and materials.

A further object of the present invention is to maintain or reduce the weight of all gloves by use of air/eva balls/gas/gel cushioning technology to eliminate heavier padding.

A further object of the present invention is to improve break in characteristics of game gloves.

A further object of the present invention is to provide a true custom fit for baseball gloves by utilizing footwear technology.

A further object of the present invention is to supplement a baseball glove with an shock absorption system comprising a low pressure bladder .

A further object of the invention is to provide a recyclable baseball glove.

It is a further object of the present invention to design shock absorption bladder/padding assemblies so as to make them suitable for either left- or right-handed gloves.

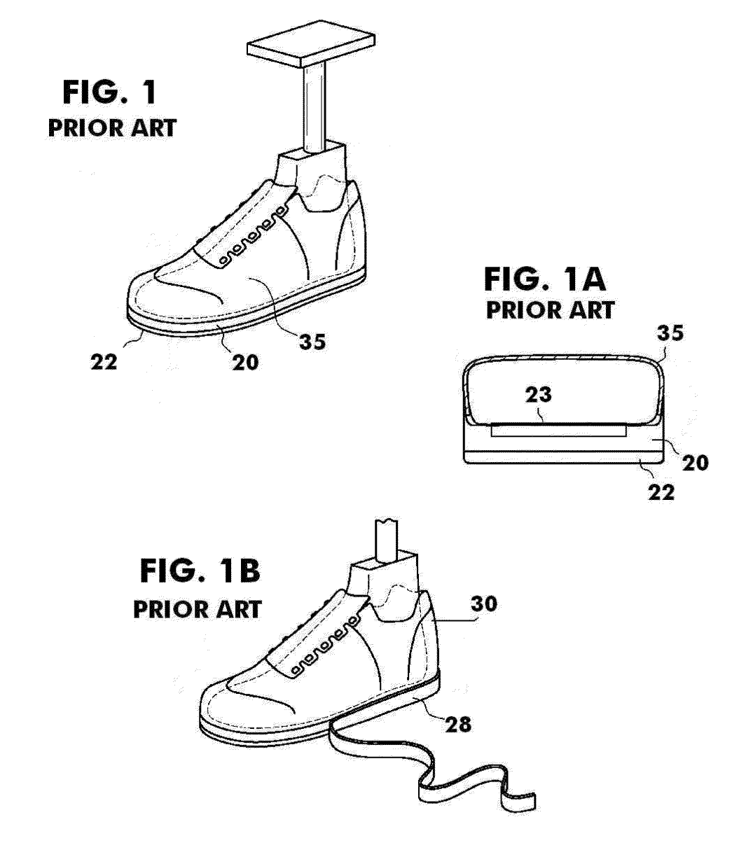

Lastly, it is an object of the present invention to improve the design features of game gloves for maximum comfort, flex and efficiency. FIG. 1 & FIG. 1a-b Prior Art 2011/0179668: a vulc style and cupsole style footwear and a method for manufacturing the footwear are disclosed. The footwear includes a midsole that is directly attached to the upper. The midsole may be attached to the outsole by adhesive. In the method of manufacturing the footwear, the upper and an outsole are disposed a set distance apart. Polyurethane or other material for providing cushioning to the footwear is either injected between the upper and outsole or poured onto the outsole and the upper is traversed over the outsole so as to define the mold for defining the midsole. The polyurethane is directly attached to the upper and adhered to the outsole/cupsole.

The foregoing has outlined some of the more pertinent objects of the invention. These objects should be construed to be merely illustrative of some of the more prominent features and applications of the intended invention. Many other beneficial results can be obtained by applying the disclosed invention in a different manner or modifying the invention within the scope of the disclosure. Accordingly, other objects and a fuller understanding of the invention may be had by referring to the summary of the invention and the detailed description of the preferred embodiments in addition to the scope of the invention defined by the claims taken in conjunction with the accompanying drawings.

### BRIEF DESCRIPTION OF THE INVENTION

A baseball glove comprising a molded resilient shell, said shell incorporating traditional athletic footwear embodiments transversely creating a new use within the glove and shoe industries. The shoe parts may include, but not are not limited to; cradle, gel, eva balls, bladders, antimicrobial cloth, air mesh fabric, uppers, saddle, midsole, outsole, lacing, velcro and glove parts; web, pocket, heel, padding, wrist strap, palm pad, flex slot, binding, finger hood, window opening, welting and shells. Our invention will merge the two industries creating an economical product with sufficient shock absorption and less parts.

It is an object of this invention to provide a molded baseball glove of reduced construction costs. The unisole structure of the present invention is lightweight, provides flexibility, rigidness and is easier to assemble than conventional midsole and outsoles. The unisole is attached to the upper by lasting and/or adhesives. In addition, the unisole reduces molding costs due to the fact that the midsole/outsole, or sole can be formed with one mold from a combined midsole/outsole material which eliminates the need for a separate outsole mold. By using one mold as compared to two molds, simultaneously reduces the thickness, cost and weight. As mentioned above, the unisole uses a combined midsole/outsole material to reduce the weight and increase the stability of the shoe.

It is another object of this invention to provide a baseball glove that has the appearance of a conventional leather glove back and sole front constructing a novel piece. Prior Art: In “vulcanized” construction, a rubber tape, about ¾ inch wide and 1/16 inch thick, is attached to the side or the top of the edge of the rubber outsole and over the bottom ½ inch or so of the upper, which could be made of any material. After the curing in the vulcanizing oven, it is virtually impossible to separate the rubber components that have been joined since they have basically been fused together. In addition to being extremely strong, a rubber-to-rubber “vulcanized” joint will not be weakened by immersion in water. A cupsole is made in a mold and the sidewalls are all “one” with the tread. Cupsoles look perfect. You can frequently see thermal marks on the vulcanized.

And yet, another object of this invention is to provide a baseball glove constructed by the method of shoe construction collaboration. Cupsole: a running shoe sole that is made using the same construction technique as a half cup sole except that the side wall extends the full length of the medial side. A full cup sole is slightly heavier and less flexible than a half cup sole but provides better support or pronation irregularities during a runners foot strike. Conversely, terminology overlaps a cupsole may be interpreted as a midsole, unisole or outsole. Vulcanization may take place in a layered midsole/outsole or unisole aplication and cupsole vulcanization combination.

In accordance with these and other objects which will be apparent hereinafter, the instant invention will now be described with particular reference to the accompanying drawings.

### SUMMARY OF THE INVENTION

For the purpose of summarizing this invention, this invention may be incorporated into an improved game glove including a no lace front portion and a no lace back portion defining a hand space there between and forming a major region for receiving the fingers of the wearer and a minor region for receiving the thumb of the wearer; an opening at one edge of the glove for the passage of the hand of a wearer into the hand space; a bladder 23 positioned in the hand space, the bladder 23 having a major portion in the major region of the glove and a minor portion in the minor region for the glove. Vulcanized 29 is the “Vans” style construction where the gum rubber sole is bonded with heat and pressure to a sidewall that is made of a rubber banding foxing 21 type material.

The invention is incorporated into a game glove formed of no lace front shell layer of material and no lace back layer 24 of material defining a hand space between the layers, the glove having an opening at an edge for the passage of the hand of a wearer into the hand space, the glove also having a major region for the fingers of the wearer and a laterally disposed minor region for the thumb of the wearer, a bladder 23 adjacent to the front layer, in the hand space before the hand of the wearer.

The bladder 23 includes a major portion in the major region of the glove and a minor portion in the minor region of the glove with an intermediate portion there between. The game glove further includes a front shell outsole 22 and/or midsole 20.

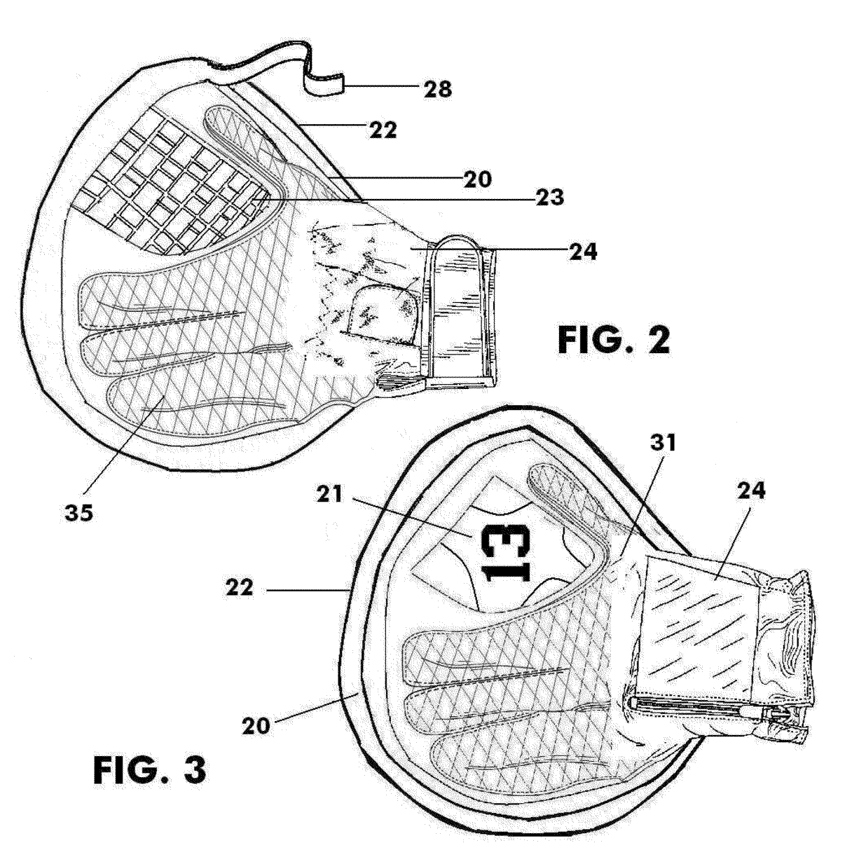

Lastly, the invention may also be incorporate a stability cradle 27. If attached on the outside of the glove/mitt these reinforcements are called foxing 28 or a saddle 31. Underneath it is a plastic cradle 27 that supports the hand The heel cup 30 is to counter or retain a ball from catch mishap. External embellishments may be added to the handwear such as a foxing 28, as shown in FIG. 2. The foxing 28 may be pre-cured and adhered to the outsole 22 and the midsole 20. The foxing 28 may be wrapped around the entire handwear. Alternatively, the foxing 28 may be adhered to only the finger portion of the handwear.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent structures do not depart from the spirit and scope of the invention as set forth in the appended claims.

### DETAILED DESCRIPTION OF INVENTION STEPS

I First, prepared rolls of synthetic material and rolls of dyed, split, and suede leather (used as part of the foxing) are sent to the factory.

II Next, die machines stamp the shoe shapes, which are then cut out in cookie cutter fashion with various markings to guide the rest of the assembly. After being bundled and labeled, these pieces are sent to another part of the factory where they'll be stitched.

III The pieces that will form the upper part of the shoe are stitched or cemented together and the lace holes punched out. These pieces include the featherline, the vamp, the mudguard, the throat (with eyestay and lacing section), the tongue, reinforcements such as the saddle or arch bandage, the collar (with Achilles tendon protector), the foxing, and the logo. At this point, the upper looks not like a shoe but like a round hat, because there is extra material—called the lasting margin—that will be folded underneath the shoe when it gets cemented to the sole.

IV Next, the insole is stitched to the sides of the upper. Stiffening agents are then added to the heel region and toe box, and an insole board is inserted.

V The completed upper is heated and fitted around a last, a plastic mold that forms the final shape of the shoe. An automatic lasting machine then pulls the upper down over the last. Finally, a cement nozzle applies cement between the upper and insole board, and the machine presses the two pieces together to bond them. The upper now has the shape of the finished shoe.

VI Pre-stamped, injection molded and cutout forms of the midsole and outsole or wedge are layered and cemented to the upper. First, the outsole and midsole are aligned and bonded together. Next, the outsole and midsole are aligned with the upper and placed over a heater to reactivate the cement. As the cement cools, the upper and bottom are joined.

VII The shoe is removed from the last and inspected. Any excess cement is scraped off.

### DESCRIPTION OF THE PREFERRED EMBODIMENTS

Referring to the drawings, there is illustrated prior art from shoe technology in FIG. 1, 1a & 1b. More particularly to FIGS. 2 thru 10a, an assortment of catcher's mitts and fielder's gloves, parts thereof respectively, each of which includes a web 26 pocket portion extending between the thumb and fore-finger portion and the little finger portion, and a heel portion in proximity to the base of the thumb portion. In catching baseballs, the ball preferably impacts in the web 26 pocket portion and the player immediately attempts to close the glove by pivoting the thumb portion toward the little finger portion by pivoting the base of the player's thumb near the heel of the hand, while keeping the fingers straight. Because the ball sometimes impacts near the end of the thumb or finger, pad protection with cradle stiffness along the longitudinal axial direction is needed to resist the bending of the thumb or finger backwards. In order to overcome these above mentioned objectives we have developed a number of pre-curved, pre-creased and integral material stiffeners by molding invention concepts:

FIG. 1 (Prior Art) is a perspective view of a footwear with a last disposed therein;

FIG. 1a (Prior Art)is a cross sectional view of the footwear shown in FIG. 1;

FIG. 1b (Prior Art) illustrates foxing wrapped around the footwear shown in FIG. 1;

FIG. 2 is a rear elevation view cupsole mitt back shell

FIG. 3 is a rear elevation view of multi layer back shell

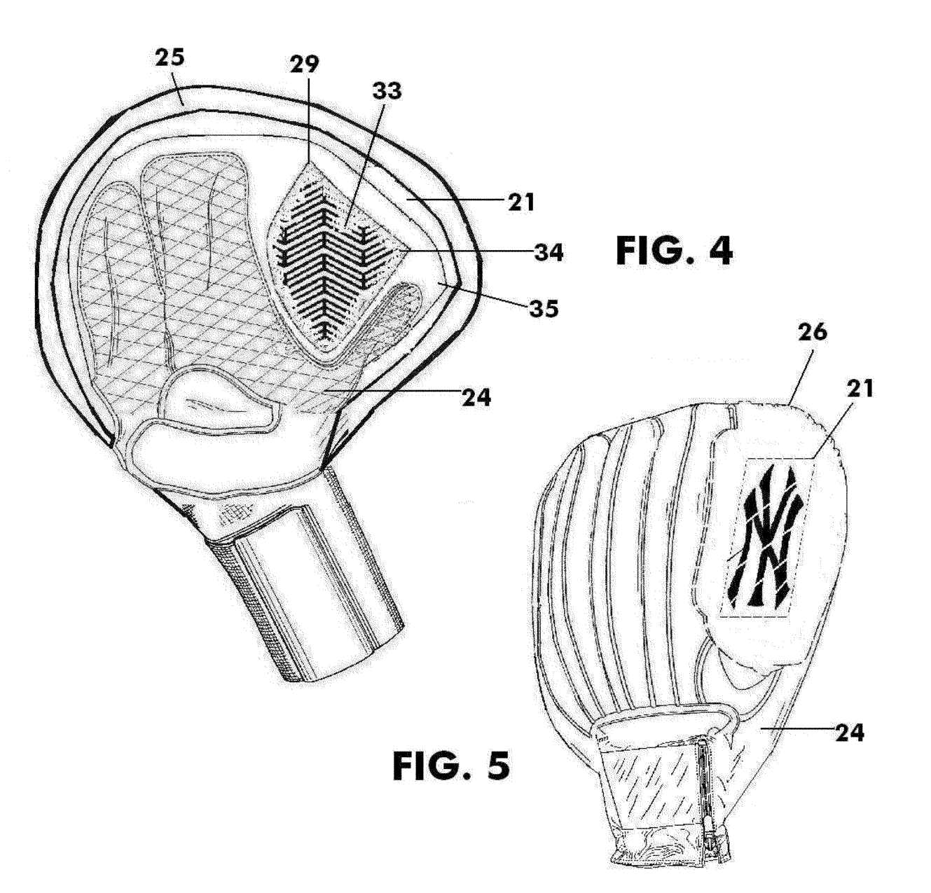

FIG. 4 is a back elevation view of sole mitt with tact vulcanized tread/sipe web

FIG. 5 is a rear elevation view of no lace back shell glove with emboss logo

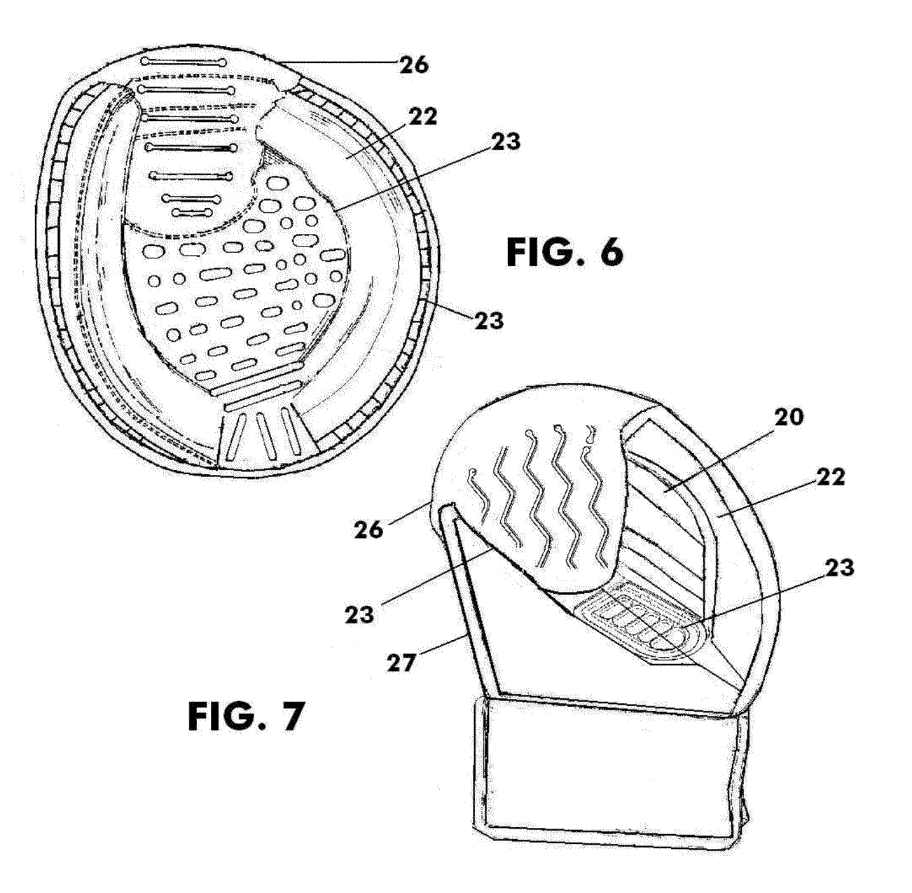

FIG. 6 is a front elevation view of no lace sole bladder mitt

FIG. 7 is a front elevation view of cupsole hockey mitt with pod and bladder web

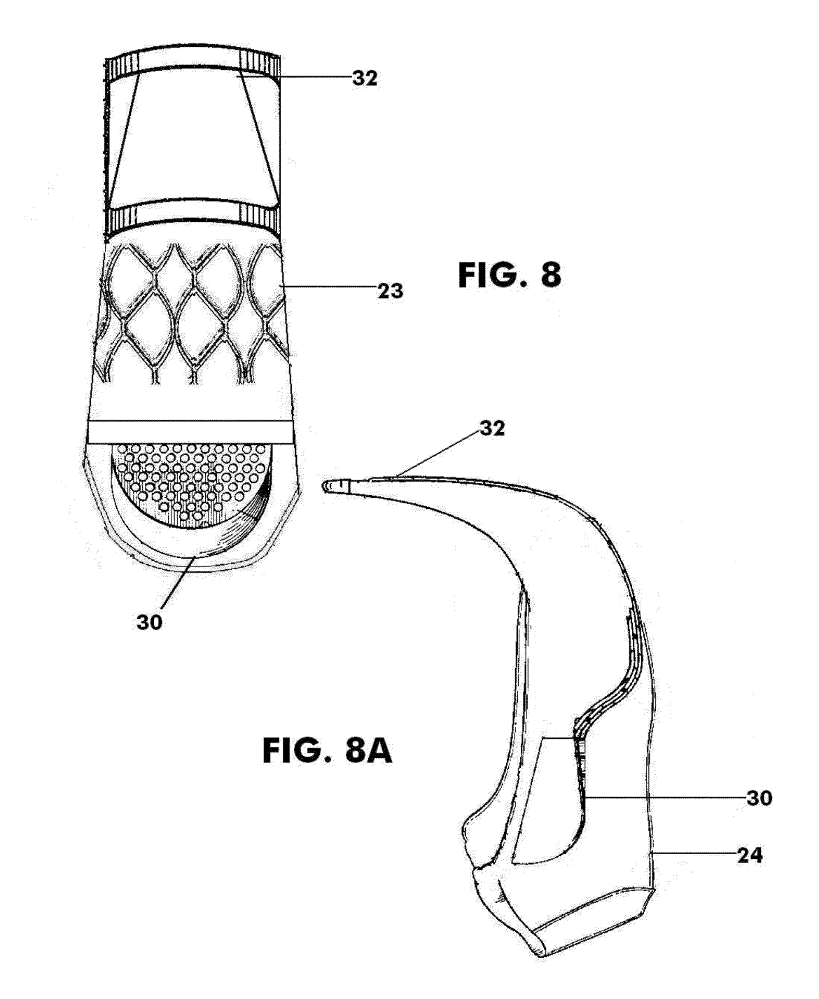

FIG. 8 is a front elevation of the sole glove with heel cup and tip

FIG. 8A is a side elevation of the sole glove with heel cup and tip

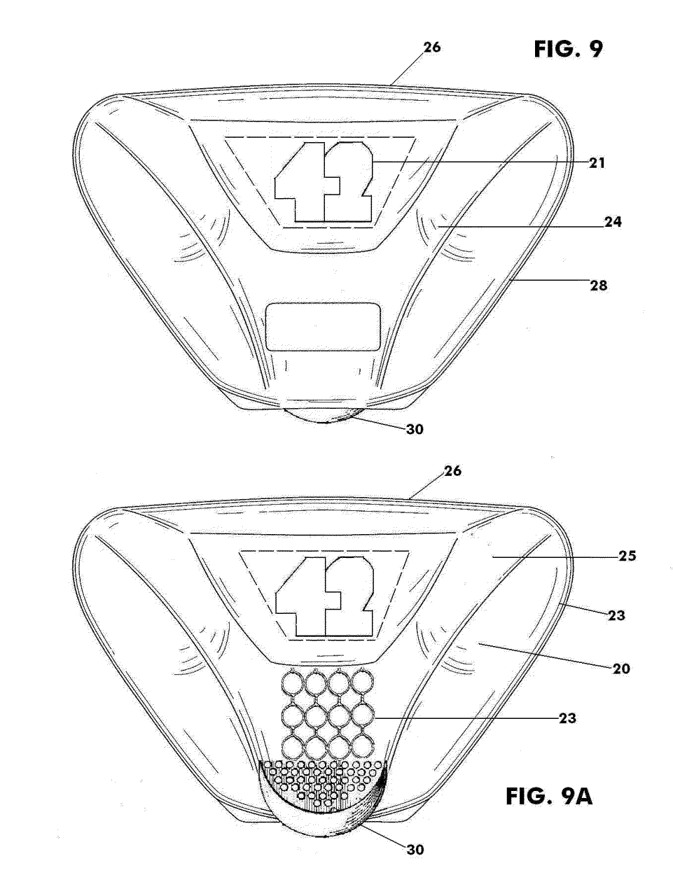

FIG. 9 is an ambidextrous reversible back shell

FIG. 9A is an ambidextrous reversible front shell

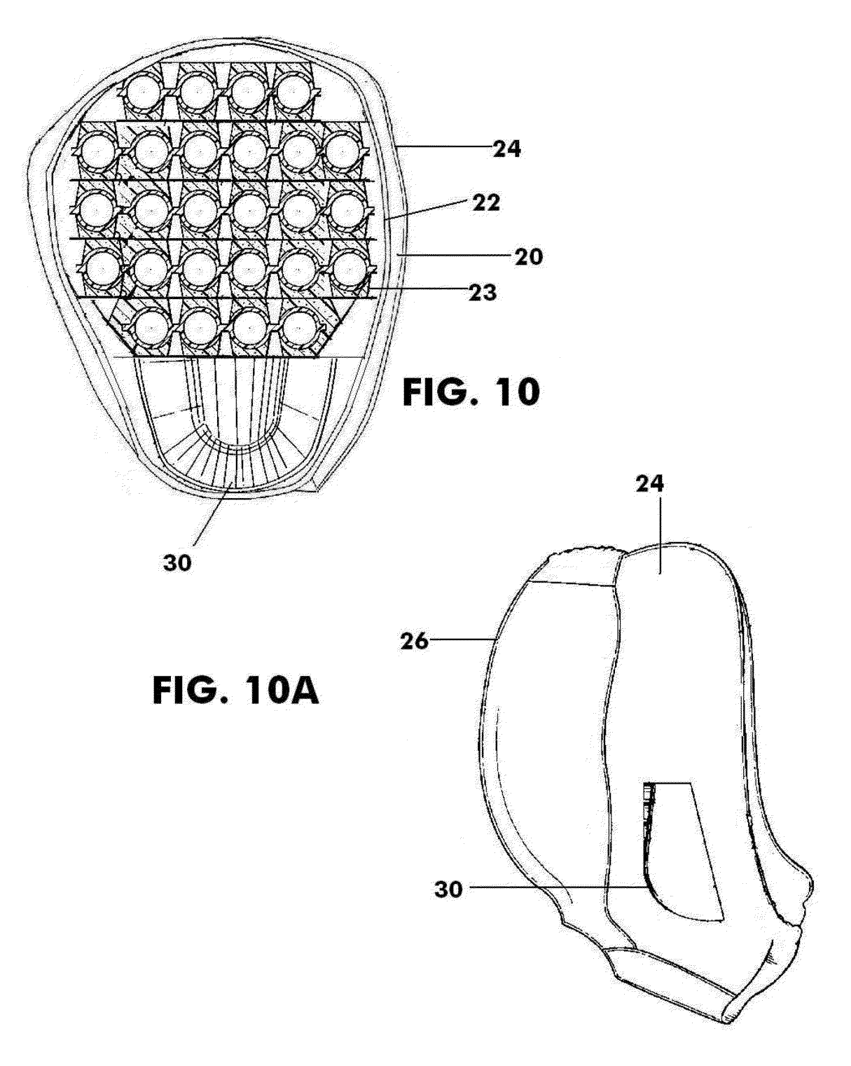

FIG. 10 is a front elevation of no lace unisole glove with heel cup

FIG. 10A is a side elevation of no lace unisole glove with heel cup

### HEEL CUP

Footwear including a sole having a front and a back for supporting a bottom of a foot. A heel cup 30 at the back of the sole receives and supports a heel of the foot. The heel cup 30 has a bottom for further supporting the bottom of the foot and a side wall extending up from the bottom.

### Upper/Saddle/Back Shell Materials

Leather or lightweight combination uppers or glove back 24, which mix the stability and durability of leather with the breath ability, and flexibility of synthetic air mesh 35. High-tech, all-synthetic uppers, which are often more durable than leather, are gaining popularity for their ability to offer stability in a super-lightweight material.

### Midsole/Outsole/Front Shell Materials

The midsole 20 is the layer of soft, shock-absorbing and/or antimicrobial material between the outsole 22 and the upper. It is often considered the most important part of a shoe, because the construction and materials used will impact the levels of pod 23 cushioning and bladder 23 shock absorption, EVA balls 23.

The outsole 22 is the rubber bottom of the shoe. Outsoles are usually made of carbon rubber, which is hard, or blown rubber, a softer type, although manufacturers use an assortment of materials to produce different textures on the outsole 22. The web 26 and palm preferably consists of a unitary relatively thin sheet of material forming an extension of the palm portion of the glove and may be comprised of a variety of materials that facilitate the capturing and holding of a thrown ball including rough surfaced and tacktified 34 resin.

### Eva/Compressed

EVA offers lightweight cushioning, EVA balls 23 add stability and durability. EVA can be compressed to make it somewhat more durable midsole 20.

### Unisole/Cupsole

The unisole 25 of a good shoe should be flat and moderately wide to create a stable base and help prevent rollover. The unisole 25 uses a combined midsole/outsole material to reduce the weight and increase the stability of the shoe. A full cupsole 27 is made using the same construction technique as a half cup sole 27 except that the side wall extends the full length of the medial side. A full cup sole 27 is slightly heavier and less flexible than a half cup sole 27 but provides better support or pronation irregularities during a runners foot strike.

### Channels /Siping Grooves

The sipe 33 grooves remove liquid (e.g. water) from the contact surface of the glove . In some example structures according to the invention, capillary action of the siping 33 grooves may suck the liquid off the contact surface of the second layer and conduct it into the depth of siping 33 groove and/or to the channels . Therefore, the contact surface is kept substantially dry, even when exposed to wet conditions. A dry contact surface is desirable because it provides better friction and grip. Therefore, removing liquid from the contact surface is extremely beneficial in increasing a wearer's gripping ability.

In the above described structures, the second layer may be disposed on the base layer at the palm-side portion so that contact areas are raised areas, or lugs, and further, so that the contact areas are created at different locations of the palm side. In some structures, the second layer may be disposed on the base layer in a discontinuous manner. One discontinuous manner may be provided by creating the second layer as a plurality of discrete and separated “islands” to thereby produce raised contact areas spaced apart from each other in particular patterns.

### Cradke/Stability/Motion Control/Welting

Stiff materials are used to saddle or cradle 27 and reduce rolling of the hand Heavier densities of cushioning materials may also be used in the medial area to increase the gloves stability. To provide stiffness to the thumb and little finger portions along the longitudinal axial direction, the layer of foam rubber is preferably of a higher density than the remaining layers and laminate structure which are comprised of a high density foam having low rebound and energy damping properties. The foam padding, unlike prior padding systems, such as felt, will not shift in the glove and will not lose its shape when not being used from the end of one season to the start of the next season. In addition, the cradle 27 may be adorned with a molded faux lacing.

### Webs

Web 26 construction emulates assembly of parts of shell layers within the glove including damping pads 23, with embossed 21 numerals, letters, and emblems including team logos and baseball fonts, inclusive in the embossed 21, mold design, alternatively constructed with webbing material or mesh 35.

### Xistera Tip

The plastic member has integral side walls extending between the tip 32 portion and the hand receiving portion forming a ball receiving region therebetween. The integral plastic tip 32 member has a partially arcuate configuration enabling the player to catch and throw the ball from the ball receiving region. The article includes resilient cushioning means secured to the ball receiving region for absorbing a portion of the impact of a moving ball to facilitate catching the ball. The embodiment comprises an improved cesta article used for the game of Jai-Alai.

### Recycle

Materials from shoes may be used after recycling, and the mitts 33 and gloves 33 also. This way the materials we use will go through many cycles of design, manufacture and use.

Outsole 22 uses environmentally preferred rubber and incorporates green rubber.

Airbag 23 made with 83% post-industrial recycled polyurethane film.

Upper mesh 24 contains 20-25% pre and post consumer recycled PET.

While the air/eva balls/gas/gel bladder 23 padding system and polyurethane soles have been shown only for catcher's mitts and fielder's gloves, it is to be understood that these structures can be used for all types of baseball gloves in slightly modified form.

The terms and expressions which have been employed herein are used as terms of description and not of limitation, and there is no intention, in the use of such terms and expressions, of excluding any equivalents of the features shown and described or portions thereof, but it is recognized that various modifications are possible within the scope of the invention claimed.

### Conclusion

In conclusion, the gloves described in the above disclosure provide several benefits through shock absorption, dissipate energy by air/eva balls/gas/gel and facilitate gripping by siping to the wearer.

While the invention has been described with respect to specific examples including presently preferred modes of carrying out the invention, those skilled in the art will appreciate that there are numerous variations and permutations of the above described structures and methods. Thus, the spirit and scope of the invention should be construed broadly as set forth in the appended claims.

Alternatively, the glove may be constructed so that the palm side of the glove may be made from a single material, such as an elastomer material, while the back side of the glove is made from a single, different material, such as mesh, weave, fabric, leather, etc. The palm side and the back side may then be attached or adhered to each other in any known fashion, such as by stitching, etc. In this structure, the elastomer material may be the only material of the palm side portion. Therefore, the elastomer material would have both the siping grooves and the channels formed in the second layer. For example, the channels would merely be a thinned portion of elastomer material while the raised contact areas would be merely a thicker portion.

Additionally, while described in detail in terms of use for baseball, those skilled in the art will appreciate that aspects of this invention may be used in a wide variety of athletic and other activities, including any activities in which gloves are worn, grip can be important, and/or damp or wet conditions may be experienced, such as hockey, jai alai, lacrosse, etc..

What I claim is:

1. A method for constructing a baseball glove/mitt sole formerly comprising, finger pad, web, welting, edge, lacing, pocket, strap, palm, tact, webbing conversely replicating components and construction of an athletic shoe, upper, sole, lace, heel cups, foxing, sipe treads, cradle, midsole, pods, outsole, unisole, saddle and bladders, having the appearance of a novel baseball glove, wherein said web emulates assembly of parts, said webs parts communicate with emboss numerals, letters and emblems including team logos and baseball fonts:
(a) a glove/mitt shell sole for handwear comprising a sole bottom portion providing a base for a tread sole portion, an upwardly rising cradle edge portion extending around the periphery of the sole bottom at the outer edge thereof, and a plurality of longitudinally distributed predetermined bending points along said edge portion, said plurality of bending points being constituted by a plurality of spaced relatively thin-walled portions in said edge portion;
(b) the glove/mitt shell sole according to claim 1, wherein said edge portion includes a plurality of web portions separating and connecting respective ones of said plurality of spaced thin-walled portions, said web portions having relatively thicker walls than said thin-walled portions;
(c) a method for making a vulcanized unisole catching tool for baseball or softball, comprising: a ball receiving portion covering the palm side of a user's hand when wearing the tool, and containing a ball receiving surface for receiving a ball, first and second resin layers selectively formed cup(s) sole only on a tact outer surface of said ball receiving portion, and a back portion covering the back of the user's hand; wherein the ball receiving portion, first resin layer, insert molded bladder and second resin layer are deformable along a surface when catching the ball, wherein said cradle is of support material and back is of antimicrobial mesh material.

2. The method of making an injection molded or stamped polymer baseball glove having the appearance of a conventional leather baseball glove comprising:
(a) forming in a cavity mold a polymer shell, said molded shell having a outer convex front surface being in shape when molded of said conventional baseball glove, said front and rear surfaces including forming finger receiving areas, thumb receiving areas and/or a web surfaces extending between the thumb and index half-finger areas;
(b) said glove front shell and back is made from recyclable materials, wherein said glove is a recycle;
(c) a handwear adhesion system comprising: a first palm component; a handwear component; and a thermoplastic film disposed between said first palm component and said handwear component, wherein said thermoplastic film joins said first palm component and said handwear component;
(d) a method of manufacturing a glove sole that includes a fluid-filled bladder, the method comprising the steps of: forming an envelope from a first outer layer and a second outer layer of barrier film material sealed along their peripheries; locating a first inner layer of barrier film material between the first outer layer and the second outer layer to define a first fluid layer between the first outer layer and the first inner layer; attaching the first inner layer to the first outer layer to subdivide the first fluid layer into at least two first chambers isolated from fluid communication with each other, at least one of the first chambers extending only partially across a width of the first fluid layer; pressurizing the first chambers with fluids having differing fluid pressures; locating a second inner layer of barrier film material between the first inner layer and the second outer layer to form: a second fluid layer located between the first inner layer and the second inner layer, and a third fluid layer located between the second inner layer and the second outer layer, that are isolated from fluid communication with each other; pressurizing at least one of the second fluid layer and the third fluid layer with a fluid having a fluid pressure that is different from at least one of the fluid pressures in the first chambers; and incorporating the bladder into the glove sole;
(e) an article of handwear having a glove that includes at least one insert at least partially encapsulated within the glove, the insert comprising: a first surface having a first perimeter with a ball shape, at least a portion of the first surface being substantially round; a second surface spaced from the first surface, the second surface having a second perimeter with a ball shape, at least a portion of the second surface being substantially round, and the second surface having fifty percent less area than the first surface; and a sidewall surface extending between the first perimeter and the second perimeter, the sidewall surface tapering inward between the first surface and the second surface, wherein a portion of the glove adjacent to the insert is formed from a first foam material and the insert is formed from a second foam material;
(f) handwear, comprising: an back and a front shell, said handsole including an outpalm and a midpalm of compressible material and having a heel region and a web region, said midpalm including a central portion of relatively soft material, a lower peripheral portion of intermediate hardness extending around the central portion in the heel region and forward along each side of the central portion to the finger region, and an upper peripheral portion of relatively hard material located above said lower peripheral portion and extending from the heel region forward along each side of said central portion, whereby the central portion absorbs shock by conforming to the contour of the hand so that the force is uniformly distributed, while the peripheral portions cradle the sides of the hand so as to limit overpronation and oversupination;
(i) a glove comprising a palm having heel and forehand areas, said palm having a perimeter and a central region, and comprising a bladder including a sealed, fluid-filled tube with resilient elastomeric walls disposed about the perimeter of said palm, said bladder including upper and lower portions extending between the medial and lateral portions of said tube, said upper and lower portions and said medial and lateral portions defining there between a sealed, fluid-filled chamber having a thickness less than the thickness of the heel area of said tube, said sealed chamber isolated out of fluid communication from said tube;
(g) a glove shell comprising a palm plate formed with a recess, and a shock absorbing cushioning member having a pair of sheets adhered together at spacings to form between said spacings a plurality of spaced gel filled chambers and an annular gel filled chamber around said spaced chambers, each of said gel filled spaced chambers and said annular gel filling chamber being filled with a non-elastically deformable gel, said recess being of a depth substantially equal to the thickness of said spaced gel filled chambers and said annular chamber, said cushioning member being received in said recess in said palm plate with air filled spaces between and surrounding said gel filled spaced chambers and said gel filled annular chamber, said gel filled chambers being deformed and said air in said air spaces between and surrounding said gel filled chambers being compressed when shock forces are applied to said cushioning member, said compressed air expanding and reforming said deformed gel filled chambers when said shock forces are repulsed.

3. A glove/mitt comprising: a base layer of a flexible material that extends along at least a palm-side portion of the glove, wherein the base layer includes a palm area and inner sides of a plurality of finger stalls and a thumb stall; and a continuous second layer positioned on the palm-side portion and disposed on the base layer so that it continuously covers at least a majority of the base layer on the palm side portion of the glove, wherein the continuous second layer varies in thickness and includes: a plurality of contact areas with siping grooves, wherein the siping grooves conduct liquid away from a contact surface of the contact areas, and a plurality of channels in which the continuous second layer is thinner than the contact areas:
a sole structure including a midpalm and an outpalm; the outpalm including a tread pattern, the tread pattern having a first nonlinear configuration; a sipe disposed on the sole structure, the sipe having a second nonlinear configuration; and wherein the second nonlinear configuration of the sipe corresponds to the first nonlinear configuration of the tread pattern;
a sealed gas-filled bladder for a glove shell comprising: a top barrier layer having a top major surface and a perimeter; a bottom layer having a bottom major surface and a perimeter; said respective perimeters of said top and bottom layers being joined to one another to form a sealed chamber, said sealed chamber containing a gas; a top columnar-shaped indentation extending into said sealed chamber from said top major surface, said top columnar-shaped indentation having a linear sidewall portion; a bottom columnar-shaped indentation extending into said sealed chamber from said bottom member; said top and bottom columnar-shaped indentations having closed ends joined to one another at a juncture within said sealed chamber; said top and bottom columnar-shaped indentations having a structure extending from said joined closed ends forming a flex point at said respective junctures that tends to buckle said columnar-shaped indentations at said juncture in response to a compressive load moving said top and bottom major surfaces toward one another, said structure defining a notch extending underneath said linear sidewall portion;
a fluid filled cushioning member for a glove shell comprising a fluid containing outer wall having a deformable indentation forming an indented wall portion in said outer wall and opening to an outer surface of said outer wall, said indentation having longitudinal and lateral axes defined generally along said outer surface and an orthogonal axis perpendicular to said longitudinal and lateral axes, said indented wall portion of said indentation being asymmetrical about at least one of said longitudinal, lateral and orthogonal axes;
a handwear comprising: an upper defining a bottom surface and an exterior shell; a midsole fused to the bottom surface of the upper, the midsole defining a bottom surface; and an outsole attached to the bottom surface of the midsole, said outsole having an inner and outer surface and at least a portion of said outer surface detackified; and
(a) a method of manufacturing handwear, the method comprising the steps of: disposing an outsole on a first plate, the outsole defining a top surface; disposing a upper in a second plate wherein the second plate is traverseable to a first position with respect to the first plate; disposing settable liquid on the top surface of the outsole; traversing the second plate to the first position with respect to the first plate so that a bottom surface of the upper is adjacent to the settable liquid on an opposite side from the outsole, the top surface of the outsole and the bottom surface of the upper defines a mold for forming a midsole from the settable liquid; curing the settable liquid to a solid state to bond the midsole to the bottom surface of the upper; and
(i) a method further comprising the step of applying an adhesive to the upper surface of the outsole to adhere the midsole to the outsole; and
(ii) a method wherein the disposing an outsole on the first plate includes disposing a cupsole on the first plate.
